(19) United States
(12) Patent Application Publication
(10) Pub. No.: US 2010/0125383 A1
(43) Pub. Date: May 20, 2010

(54) ELECTRONIC METHOD OF CONTROLLING PROPULSION AND REGENERATION FOR ELECTRIC, HYBRID-ELECTRIC AND DIESEL-ELECTRIC MARINE CRAFTS, AND AN APPARATUS THEREFOR

(76) Inventor: Pierre Caouette, Hallandale Beach, FL (US)

Correspondence Address: MCDERMOTT WILL & EMERY LLP, 600 13TH STREET, N.W., WASHINGTON, DC, 20005-3096, US

(21) Appl. No.: 12/612,383

(22) Filed: Nov. 4, 2009

(30) Foreign Application Priority Data
Nov. 14, 2008 (CA) 2,643,878

(51) Int. Cl. G05D 1/00

(52) U.S. Cl. 701/21

(57) ABSTRACT

A method of programming and setting parameters for a computer unit that regulates the interface between the operator of a marine vessel and the vessel's electric generation and propulsion systems. The invention describes the regulation of energy producing devices, energy storage devices and drive motors and propellers in both propulsion and regeneration modes. This invention simplifies and automates most of the operation of marine electric, hybrid electric, or diesel electric propulsion because the only controls requiring operator intervention are three generator modes: OFF, AUTO and ON, an alarm, an override switch and one or more throttle(s). This helm control can be duplicated in different areas of the vessel. All automatic modes required to regulate forward movement, reverse, emergency power, zero drag, propeller freeze and regeneration are all controlled by a logic using a combination of generator mode, the position of the throttles, the speed and the stored parameters of the vessel.

### FIELD OF THE INVENTION

The field of the invention relates to the definition, programming and parameterisation of an electronic management computer to interface and integrates all aspect of a sophisticated energy efficient marine propulsion system and the operator.

### BACKGROUND OF THE INVENTION

In a typical sea going vessel, including those with strictly diesel, diesel electric, electric parallel/serial hybrid and strictly electric power plants, the demands on the operator in the form of power management, propulsion and energy storage monitoring make the operation increasingly complex. As in commercial aviation, the marine technology is moving toward more computerisation and more efficient systems that increasingly require the intervention of automation to utilise the full benefits of the new systems. Computer interfacing has been done in aviation with great success, and is now just starting to appear in other modes of transportation. The slow appearance of automation in other transportation systems is because a simple transfer of technology is not possible without inventing new control system logic between components and interfacing often different and incompatible data formats. Marine vessels smaller than 100,000 lbs have different requirements than those of large cruise ships with round the clock technical staff and expertise on hand to operate the vessel. Intelligent interfacing separates the operator from the vessels systems and allows functions and efficiencies that could be difficult to achieve and maintain on a vessel of the manual type. One example of intelligent interfacing is the dynamic regeneration mode proportional to boat speed and power requirements. A second example is vessel translation in all axes irrespective of vessel heading, by the simple addition of a 3 axis joystick and limited steering sail drives or pod drives.

The sea is not always gentle and operators are sometimes over extended or temporarily replaced by less experienced personnel. It is desirable to eliminate as much of the burden of the operation as possible while providing as much help in monitoring and automation as possible. With the advent of electric propulsion with virtually no maintenance, high capacity energy storage having very low resistance and very efficient energy producing devices, the need to optimize all aspects of the devices used together for vessel operation becomes crucial. Most importantly, the utility of automating marine operation is to also make the systems friendly to pleasure craft boaters operating vessels smaller than 100,000 pounds that do not have the experience or training to operate equipment that requires a high level of manual control and who do not have the knowledge to trouble-shoot the systems.

In today's marine vessels, operators must manually turn on and off multiple devices always keeping in mind the safe and efficient operation of his vessel. As more and more of the devices installed on marine vessels are themselves automated but in often incompatible languages, data formats or operating systems, it is desirable to adapt a computer system to monitor and automate as much of the operation and translation as is possible while giving a multitude of benefits back to the operators.

In U.S. Pat. No. 7,482,767 (Tether et al., 2009) a watercraft regeneration system is described that requires at least one electric motor capable of generating electricity and a controller for the motor. This watercraft regeneration system uses propeller drag to regenerate energy but suffers from two issues: 1) the described system fails to control of regeneration to limit battery charging, which may lead to overcharging of the batteries, which is undesirable, and may be hazardous; 2) there is no automatic mechanism to control propeller drag, which has a serious effect on the performance of any sailing vessel. The described system has no automations features making its operation very complicated and therefore of limited use.

The invention described in U.S. Pat. No. 7,482,767 describes the use of a motor controller to control the electric motor and regeneration by the electric motor. Motor controllers are well known in the art for use in controlling function of electric motors. However, motor controllers are not built to receive data from the battery, nor do they automate battery charging, nor do they receive data on boat speed. Therefore, the system described by Tether et al. cannot automatically control limited drag regeneration, no drag, prop freeze, emergency power without input from the operator.

### SUMMARY OF THE INVENTION

The main goal of the present invention is the elaboration of the programming software and adjustable parameters, computer and communication requirements that can serve to provide an interface between the operator and the vessel's systems. A listing of the different operating modes, their complexity and automations criteria is explained in the text and in the logic flowcharts which follow. An advantage of the present invention is that better regeneration control is achieved, and the associated drag is also better controlled.

Propulsion and power management of marine vessels are getting increasingly complex. Operators of sailing vessels have been very slow to adapt to changes in hybrid electric propulsion systems seen in automotive industries because of the complexity of operating the currently available systems. To move the marine industry away from fossil fuels, it is critical to provide intelligent logic systems to control the integration of the boat systems. The inventor of the present invention had such an experience as a commercial airline pilot, having lived through the conversion from manual operation to the “fly by wire” revolution in the 1990s. Airbus was the first to introduce into subsonic commercial aviation a computer interface between the aircraft systems and the pilots thereby eliminating any physical link between them. Today it is clear that the benefits of the computer interface far outweigh the loss of manual controls. A well implemented marine automation system with related automatic or manual backups, will simplify the manufacturing of marine vessels, reduce the workload on its operators, reduce maintenance requirements, allow better tracking the operation, and save fuel. In cases of extreme emergency or weather conditions, automated systems could save lives.

In one aspect of the invention, a hybrid-electric marine vessel has all or part of the vessel propulsion power supplied by an electric motor and has an on board electric energy storage to assist the primary power unit during the vessel's momentary large power requirements. The energy storage unit can be charged from available excess primary power and/or regeneration energy supplied from the electric motor/generator during sailing. In this method, the high voltage energy storage unit also supplies power to operate vessel accessory subsystems such as the heating, ventilation, and air conditioning (HVAC) system, hydraulic system, equipments and various low voltage (12 volt or 24 volt) standard accessories through a bi-directional DC/DC charger/converter. This also allows low voltage energy producing devices as solar panels and wind generators to become an integral part of the whole system.

The major hybrid-electric drive components are an internal combustion engine mechanically coupled to an electric power generator, an energy storage device such as a battery pack or an ultracapacitor pack, and an electrically powered traction motor mechanically coupled to the vessel propulsion system. The vessel has accessories that can be powered from the energy storage and vessel operation does not require that the engine be running for low power movements. In fact, an OFF position on the generator control allows limited electric only operation to get in or out of marinas or to get in or out of pollution free and noise sensitive areas. The electric generator/motor, energy storage, and traction motor/generator are all electrically connected to a high voltage power distribution network.

An ON position is also available on the generator control in case the operator wants to make sure emergency power is available and that the energy storage is fully charged prior to a prolonged period where running the energy producing devices should be avoided.

For a parallel hybrid-electric configuration the engine and the electric traction motor are both mechanically connected to the vessel propeller. Furthermore, the parallel configuration has an electric traction motor that can also act as a generator and includes the capability to mechanically decouple the engine-generator combination from the vessel propeller via the transmission, thus allowing generator only operation and an electrically activated clutch between the diesel portion and the electric portion of the generator allowing electrical only propulsion. As long as an energy storage device with sufficient energy is available on such vessels, especially on vessel equipped with more than one such parallel hybrid motor, the efficiencies of serial electric optimum generator loading can be achieved while avoiding the inherent inefficiencies of the strictly diesel electric vessels.

An aspect of the present invention involves a method for controlling the automatic shut down and restart of the diesel engines used for generation. Even if automatic start/stop is not new, for efficiency, weight saving and in order to reduce the mechanical wear, this system reverts the generator into a motor and uses it to spin the gas/diesel engine to idle speed and once started reverts back the motor/generator to its energy producing role. This system allows multiple and/or fast starts in response to a sudden energy requirement or throttle movement, which could not be achieved easily by a normal low voltage inefficient and temperature/time sensitive gear/clutch driven common starter.

During sailing, or on vessels equipped with multiple generators, as soon as the loads allow and the energy storage reaches a predetermined level or regeneration is possible, the generator or some of the generators will automatically shutdown unless the generator ON function was activated. One part of the invention is the implied simplicity of operation of the system, apart from the power throttles, the only controls requiring operator intervention are the 3 generators modes: OFF, AUTO and ON. The remaining modes needed to operate a vessel, such as forward movement, reverse, emergency power, zero drag, propeller freeze and regeneration are all controlled by a programming logic using a mix of throttle(s) position, the speed and stored parameters on the vessel.

The benefits and utility of the systems described herein include reduced noise, reduced fossil fuel consumption, and the ability to regenerate power (regeneration). The present invention will improve comfort, decrease weight, allow a better weight distribution to give better sea going performance, and increase usable volumes inside the vessel. The optimum placement of the devices will also allow better hull design. All of the above benefits result from a change from traditional diesel propulsion toward electrical propulsion. Implementing a strong intelligent electronic interface between the operator and the vessel is a critical step that is currently lacking in the industry.

Through the same main computer system, on vessels with more than one propeller, the addition of one or more three-axis joysticks would, in conjunction with steerable sail drives or pod drives, allow movement of the vessel in all directions, irrespective of the heading.

Thus, in one embodiment of the invention, there is provided a method for implementing and programming an electronic computer interface (Main Controller) between an operator and on-board devices of a marine vessel, for monitoring, communicating and managing power generation, storage, regeneration and propulsion thereon, said marine vessel including at least one propulsion system, comprising the steps of:
(a) providing a high voltage storage unit;
(b) providing a low voltage storage unit;
(c) providing a DC/DC bidirectional charger/converter;
(d) providing a main controller, said main controller being operatively connected to said high voltage storage unit, said low voltage storage unit, said bidirectional charger/converter and said at least one electric propulsion system; and
(e) providing a helm controller, operatively connected to said main controller, wherein functions of power generation and propulsion are managed without user intervention based on said operator controlling a throttle and a generator mode through said helm control.

In another embodiment of the invention, there is provided a system monitoring, communicating and managing power generation, storage, regeneration and propulsion on a marine vessel, said marine vessel including at least one propulsion system, said system comprising:
a high voltage storage unit;
a low voltage storage unit;
a DC/DC bidirectional charger/converter;
a main controller, said main controller being operatively connected to said high voltage storage unit, said low voltage storage unit, said bidirectional charger/converter and said at least one electric propulsion system; and
a helm controller, operatively connected to said main controller, wherein functions of power generation and propulsion are managed without user intervention based on said operator controlling a throttle and a generator mode through said helm control.

### BRIEF DESCRIPTION OF THE DRAWINGS

The accompanying drawings, which are incorporated in and form a part of this specification, illustrate the logic flow or flowchart of the invention and its embodiments, and together with the description, serve to explain the principles of this invention. Thus, the present invention will be better understood after reading a description of a preferred embodiment thereof, made with reference to the following drawings, in which:

FIG. 1 is a block diagram of an embodiment of a series hybrid-electric drive system with electrically powered accessories. The bold lines and boxed show high voltage devices and the line lines and boxes show low voltage devices;

FIG. 2 is a block diagram of an embodiment of a parallel hybrid-electric drive system with electrically powered accessories. The bold lines and boxed show high voltage devices and the line lines and boxes show low voltage devices;

FIG. 3 is a block diagram of an embodiment of a fuel cell hybrid-electric drive system with electrically powered accessories. The bold lines and boxed show high voltage devices and the line lines and boxes show low voltage devices;

FIG. 4 is a drawing of the operator interface to the computer, example of throttle, generator controls, system warning and power and energy displays;

FIG. 5 is a drawing of the manual helm controls, the computer interface and its inputs and outputs;

FIG. 6 is the logic for the Generator Switch Mode;

FIG. 7 is a drawing showing the logic for Idle Reverse Mode;

FIG. 8 is a drawing showing the logic for Forward Mode;

FIG. 9 is a drawing showing the logic for Idle Forward Mode; and

FIG. 10 is a drawing showing the logic for Reverse Mode;

### DETAILED DESCRIPTION OF THE INVENTION

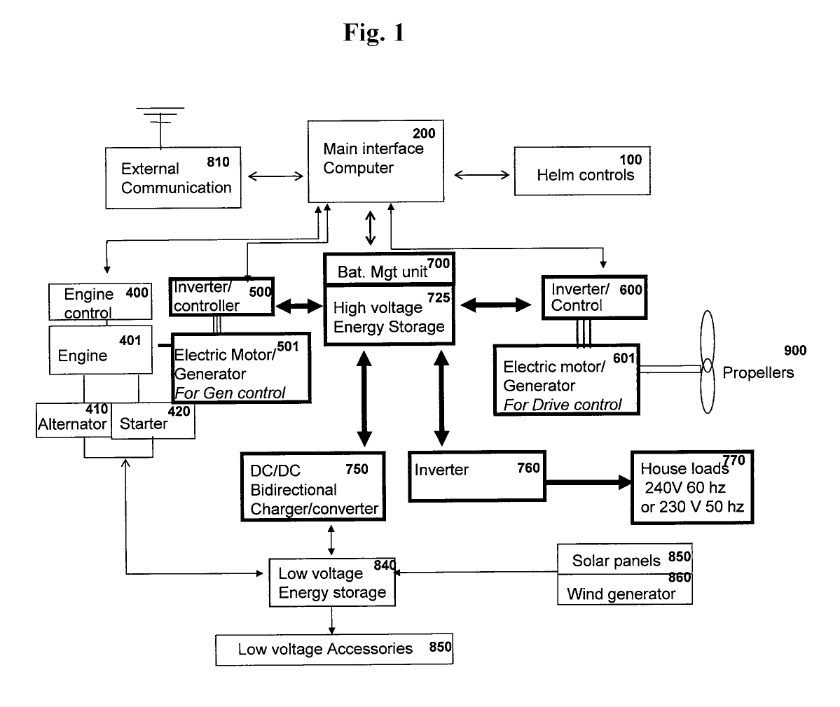

With reference to FIG. 1, an embodiment of a single generator/single motor series hybrid-electric drive system with both high and low voltage electrically powered accessories is shown. For multiple generators or drives systems, the same layout applies, with the appropriate modifications.

The principles of the present invention center on a large high voltage energy storage device, a bi-directional DC/DC converter, and a small, low voltage energy storage device. The whole system can be operated without using the generator. For normal engine start and stop, the generator is inverted into a motor and will spin the engine to start it. (See the example at the end of the present description). Once the motor load drops, meaning that the engine has started, the motor will revert into a generator and supply high voltage to its associated energy storage unit.

In the case that the high voltage storage unit does not have the minimum power required for a normal start, a backup system will use the low voltage energy storage to supply the attached low volt starter for engine start. (FIG. 1, 840-420-401) Once the engine/generator is operating, the low volt alternator (required for emergency operation or high voltage storage fault) will also supply power to the low volt energy storage and could through the high volt to low volt bi-directional converter, convert to the high volt if necessary. (FIG. 1, 401-840-750-725) This intelligent bi-directional DC/DC converter/charger is programmed to convert high voltage to low voltage or the opposite as soon as one of the respective energy storage devices is above float voltage level. This ensures that the low voltage energy storage unit has the energy to power the on-board low voltage electronics, other low voltage devices, and, in an emergency, start the motor. An additional benefit of using a bi-directional charger/converter is that it permits the use of additional energy producing devices like solar panels and wind generators that are usually connected to the low volt storage units. (FIG. 1, 850/810-840-750-725) Once the low voltage storage unit reaches capacity, the excess power is redirected to the high voltage side.

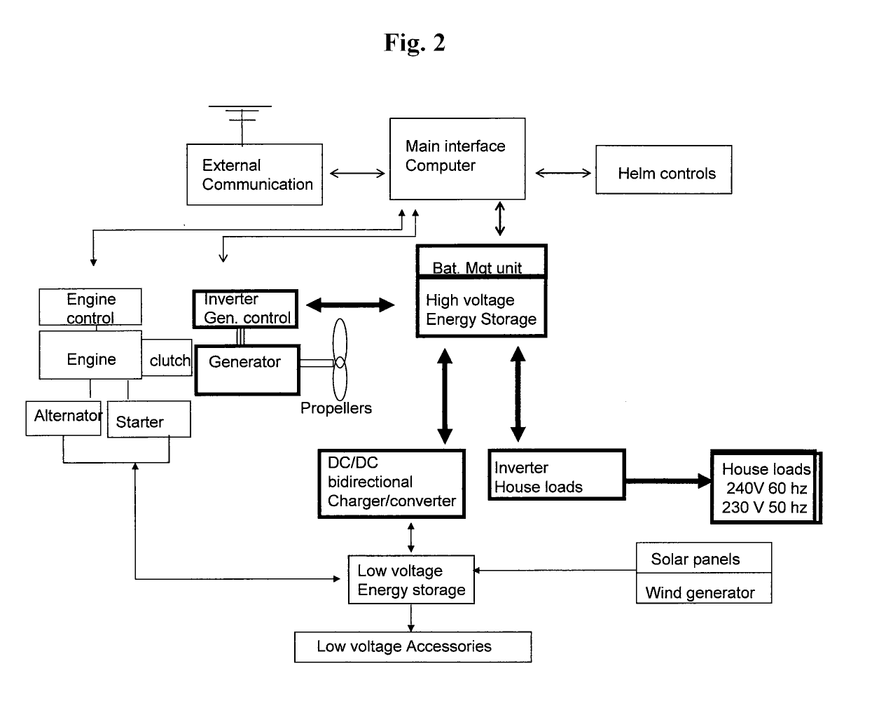

FIG. 2 embodies a parallel-hybrid type of installation where the generator is also the main propulsion engine with a high capacity generator/motor installed in-between. To get the most benefit of this type of installation, an electric clutch is placed between the engine and the generator which allows electric only operation through the high capacity high voltage energy storage unit. This type of installation would be effective on single engine vessels and especially mono-hull sailboats. It is not as efficient and flexible as the serial hybrid but it is a nice compromise, as high efficiency permanent rare earth magnet motor/generators are expensive. In certain modes of operation, medium to high power cruising for example, one can achieve better fuel per miles than serial hybrid because this system avoids some of the thermodynamic energy loss in power conversion, but only if the engine RPM can be maintained at optimum level. This system still maintains the benefits of electric only operations: regeneration, zero drag, freeze prop and emergency power.

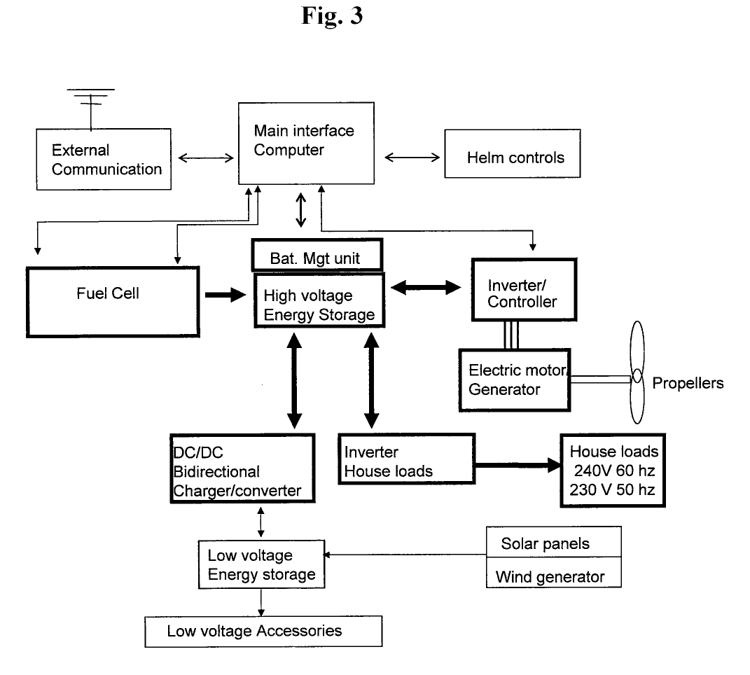

FIG. 3 embodies a fuel-cell hybrid type of installation. This type of installation on a boat has a lot of potential because it is quiet and clean, and the only by-product is warm pure water (great for sea going marine vessels). If the installation is on a sailing vessel, excess electric power from regeneration could even be used to replenish the hydrogen tank from electrolysis of sea water. Currently, unless the hydrogen is supplied by a hydro regeneration station, solar or wind power, hydrogen usage cannot be called clean because most of the world's hydrogen is produced from not so clean power (fossil fuel or nuclear). The fuel-cell installation on the described a system would be extremely easy to install, and it is expected that as fuel-cell technology develops further, the cost-benefit will improve.

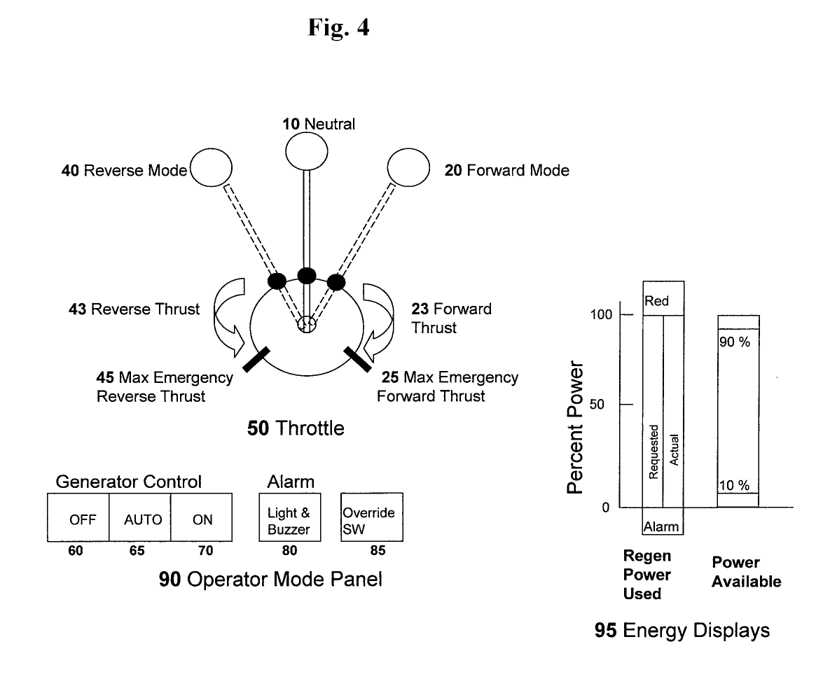

FIG. 4 illustrates the helm controls. As shown in the control panel (50 and 90), there are very few switches, controls and displays the operator must manipulate or scan, compared to older technology marine vessels with comparable equipments. The power display 95 allows the operator to monitor regeneration and current power levels. This system can be easily duplicated for vessels with large decks or requiring controls inside and out of the bridge.

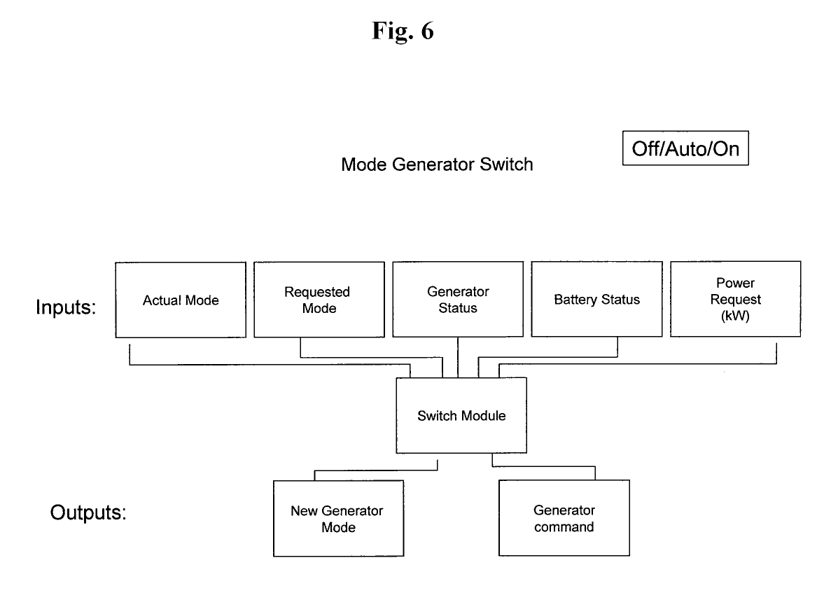

As shown in FIG. 4, the main operator controls are the throttle(s), 3 generator(s) switches (OFF, AUTO, ON), one alarm light/buzzer and one override switch. The familiar throttles are electronic lever(s) with full fore and aft travel and three detents in the middle of travel 40,10, 20. These three detents are: Reverse Detent 40, Neutral Detent 10 and Forward Detent 20. Each of theses positions will command different operating modes through the central computer, depending on the vessel's generator status and/or speed through the water. (See FIG. 6 for logic overview)

The generator switch OFF mode (FIG. 4,60) will be electric only operation, the AUTO mode (FIG. 4,65) will be the normal operating setting for generator automatic start, stop and regeneration mode, propeller freeze and zero drag mode. The ON mode (FIG. 4,70) will be an abnormal setting where the generator will operate continually and the batteries will be fully charged, contrary to the AUTO mode (FIG. 4,65) where the batteries will alternate between 10% and 90% charge (parameter configurable limits). ON (FIG. 4,70) is the mode an operator would select in case he or she wants the batteries fully charged or in case emergency power is required (combination of generator and energy storage unit).

With the generator switch is in OFF mode (FIG. 4,65), the throttle(s) will act in a normal fashion but with the restricted abilities of the available power from the energy storage unit. The main computer will display at the helm station the amount of power used in forward or reverse and a computed storage state (100% to 0%) using an equation built on current and voltage mix, or data from the Battery Management Computer, should it be available.

An alarm visual and auditory will sound (FIG. 4,80) when the storage unit is depleted to a preset level of 10% (configurable) reminding the operator to select AUTO or ON, on the helm generator switches. The auditory function can be disabled by the operator (FIG. 4,85) but the visual warning will remain and such usage will be logged in the system memory because it could affect the life of the energy storage unit.

With the throttle is in the middle (Neutral Detent) position (FIG. 4, 10), the propeller will be in freeze mode (see flow chart, Example 3), a mode that stops the propeller from turning. Stoppage is accomplished by sending a very low current (0.2 amps parameter configurable) in two opposing phases on the drive motor effectively freezing it.

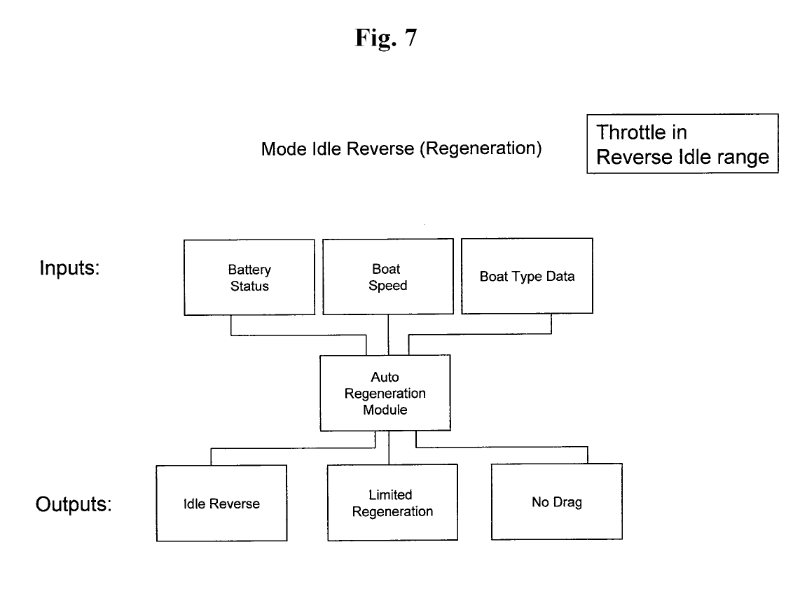

With the throttle in Forward Idle detent position (FIG. 4,20) and the generator switch in AUTO mode (FIG. 4,65); the main computer will check the vessel speed. (FIG. 7 for logic overview) If the Speed is low, (default is less than 4 knots parameter configurable) it will order the motor controller to rotate the drive motor in forward thrust at around 100 rpm (parameter configurable); should the throttle be advanced past Forward Idle (FIG. 4,20) toward forward thrust (FIG. 4,23), the motor will accelerate following the throttle movement but in a logarithmic fashion, accelerating the motor slowly in the beginning of the throttle travel then exponentially increasing thrust as the throttle movement accentuates toward the full position. As the thrust increases to a level above a certain specific drain of the energy storage unit, the generator will start and assist in propulsion. If the power required is below the optimum generator power band, the exceeding power will be used to recharge the energy storage unit, once a predetermined charged level is attained and the thrust requirements are within the energy storage capabilities, the generator will be shut down automatically until required again. If the Speed is above the low parameter and the throttle remains in Forward Detent (FIG. 4,20), (most likely a sailing vessel) the main computer will engage the Low Drag Mode. The main computer will order the motor controller to induce a current of approximately 0.4 amps in forward rotation (parameter configurable), which will cancel the drag induced by a fixed or freewheeling propeller at a very small penalty. The purpose of this mode is to encourage the installation of high pitch and multiple blades propellers that are much more efficient in both propulsion and regeneration. Should one install a folding, or some feathering propellers, this mode can be disabled. Should one wish to install a variable pitch propeller, a subroutine will be enabled in the Main Computer (as it is also programmed with this option in mind) to optimize the pitch angle actuator with the electric motor.

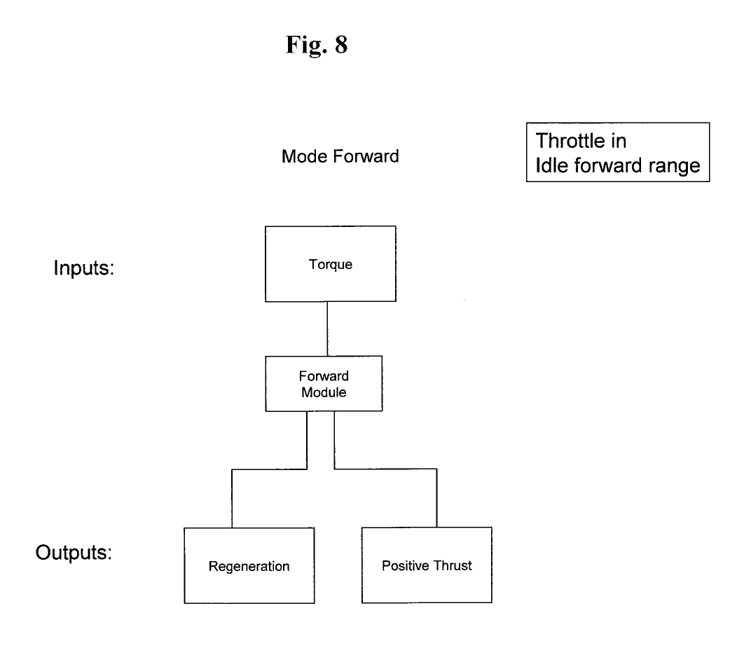

With the throttle lever moved out of the Forward Idle detent (FIG. 4,20) into forward trust mode (FIG. 4,23), the system will be in RPM mode displaying from 5% to 100%. Should there be more than one motor, an automatic synchronization mode will engage anytime the motors are within 50 rpm (configurable) of each other. Should a harmonic noise from the synchronized props be detected, a prop de-phasing parameter could be applied in the Main Computer so that the propellers are not in the exact same position during rotation. If the Main Computer detects while sailing that to maintain a certain RPM the motors load diminishes to zero, it will flip the motor controller into Regeneration Mode and use some of that extra speed to recharge the Energy Storage Unit (This flipping of mode back and fourth can be done extremely fast as the same motor controller logic that is used in land vehicles for regenerative braking is used). (FIG. 8 for logic overview) This motor sailing type of operation is often used on long trip on a sailing vessel when the operator wants to increase the boat speed just a little to change the wind angle. The speed benefits of this technique can be amazing in large swell or in gusty condition and can sometimes save more power than it uses.

With the throttle in Forward Idle detent position (FIG. 4,23) and the generator switch in ON mode (FIG. 4,65), the main computer will check the vessel speed. If the Speed is low, the operation will be similar to the previous example with the following exception: full power will be attained on the throttle reaches 90% travel. As the thrust is increased further, this will be considered an Emergency Thrust request (FIG. 4,25) by the main computer and energy storage unit will assist the generator in providing more power to the drive motors. Assuming that the storage unit is fully charged, the thrust could be increased up to 150% of normal, but for a limited time. This time limit will be controlled by a function of timing, temperature sensing and energy storage depletion. Once the computed limit has been reached, the power will be reduced to maximum available assuming no energy storage boost. If the Speed is above the low parameter and the throttle remains in Forward Detent (FIG. 4,20), (most likely a sailing vessel) the main computer will engage the Low Drag Mode, as described above and the generator's sole purpose will be to charge the energy storage to 100% and provide for vessel electrical loads. (FIGS. 8 & 9 for logic overview)

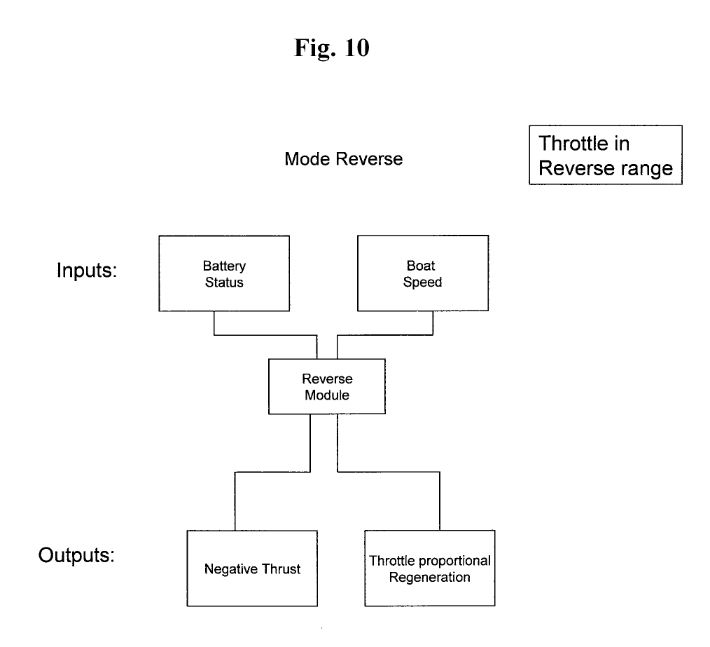

With the throttle in Reverse Idle detent position (FIG. 4,40) and the generator switch in AUTO mode (FIG. 4,65) the main computer will check the vessel speed. (FIG. 7 for logic overview) If the Speed is low, (default is less than 4 knots parameter configurable) it will order the motor controller to rotate the drive motor in reverse thrust at around 100 rpm (parameter configurable). Should the throttle be moved past Reverse Idle to reverse thrust (FIG. 4,43), the motor will accelerate following the throttle movement using the same preferable logarithmic fashion, accelerating the motor slowly in the beginning of the throttle travel then exponentially increasing thrust as the throttle movement accentuates toward the full reverse position. As the thrust increases to a level above a certain drain level of the energy storage unit, the generator will also start and assist in reversing. If power required is below the optimum generator power, the exceeding power will be used to recharge the energy storage unit, once a predetermined charged level is attained if the thrust requirements are within the energy storage capabilities, the generator will be shut down automatically until required again. (FIG. 10 for logic overview)

If the Speed is above the low parameter and the throttle remains in Reverse Detent (FIG. 4,40), (most likely a sailing vessel) the main computer will engage the Regeneration Mode. The main computer will flip the motor controller into regenerate mode and using boat speed and energy storage state, the computer will determine the optimum load to extract from the motor using a formula based on number of hull, weight, length and width at the waterline. This is an interesting feature of invention as at low vessel speed, it is easy to stall the blades or even to stop the propeller from turning with even a small regeneration load. As water speed increases, the power that can be extracted increases exponentially. This power extraction mode is limited in Idle Reverse (mode) so as to limit the penalty on speed, sailing vessels are very dependent on relative wind keeping in mind the maximum hull speed of the vessel and whether it is a displacement hull or not (heavy mono-hull sailboats versus light catamarans). With boat speed above the low parameter and throttle(s) in reverse (FIG. 4,43), the system will be in open regeneration based on throttle position, until boat speed drops bellow the low speed trigger or until the propeller stop, at which point, the motor will enter into reverse rotation proportional to throttle angle.

In a sailing vessel on a long passage across an ocean, independent regeneration of power is an important advantage. On a long crossing in trade wind conditions, using regeneration, for example for less than two hours a day, would be enough to replenish a full days usage of the energy storage units. When the High Energy Storage Unit (FIG. 1,725) indicates a 90% charge, if the throttle is not replaced into forward detent (FIG. 4,20) from reverse detent (FIG. 4,40), the system will automatically flip the motor controller(s) into motor mode again and the Zero Drag mode will be enabled until the Energy Storage Unit signals a low level where the cycle will repeat. If the throttle is moved out of the Reverse Detent mode (FIG. 4,40), normal operation will resume. This system, therefore, automates the regeneration mode with virtually no operator assistance.

With the throttle in Reverse Idle detent position (FIG. 4,40) and the generator switch in ON mode (FIG. 4,65):

If the Speed is low, (default is less than 4 knots parameter configurable) the Main Computer will order the motor controller to rotate the drive motor in reverse thrust at around 100 rpm (parameter configurable). Should the throttle be retarded past Reverse Idle (FIG. 4,43), the motor will accelerate following the throttle movement but in a logarithmic fashion, accelerating the motor slowly in the beginning of the throttle travel then exponentially increasing thrust as the throttle movement accentuates which will achieve normal 100% power upon reaching approximately 90% of the full Reverse throttle position. As the reverse thrust is increased further, this will be considered an Emergency reverse Thrust request (FIG. 4,45) by the main computer, and the Energy Storage Unit will assist the generator in providing more power to the drive motors. Assuming that the storage unit is fully charged, the reverse thrust could be increased up to 150% of normal, but for a limited time. This time limit will be controlled by a function of timing, temperature sensing and energy storage depletion. Once the computed limit has been reached, the power will be reduced to maximum reverse available assuming no energy storage boost.

FIG. 4. shows the power displays. The display is designed to provide all the information required for operation without numerous controls by automating most of the processes. For example, how do you gage the state of charge of an Energy Storage unit? The state of charge is easy to determine if energy storage has been idle for a while with no load on it where the voltage can be used in relation to a table to estimate charge. This situation is infrequent because most of the time, there are alternating loads on both the high voltage and low voltage sources. With a load there is a corresponding instantaneous voltage drop that has nothing to do with the real state of the Storage unit. Therefore, should energy storage status not be available from the Battery Management Computer, an equation in the Main Computer to take the variable voltage and current to supply information for its own start/stop routines and for Helm Display. The helm display show two different parameters: Power from 0% to 100%; the second display represents percent power used. This display goes from −25% to +150%. 0% to 100% is easy to explain with the exception that the scale adapts as to whether we are on Electric Only (OFF mode) or in Generator when needed (AUTO mode). If we were in the abnormal (ON mode) then power could go from 0% to up to 150% assuming that the Energy Storage units is fully charged, the last 50% turns the display red on color displays and flashes on monochrome displays.

FIG. 4 also shows an Override switch 85. The function of this switch is first to cancel an audible warning. Doing so will not cancel the visual warning as the system is programmed to expect the operator to correct the situation. The second function is for vessels with multiple Helm Controls. If the operator moves from one helm control (inside the vessel) to another one (on the bridge) and he had set the control in a certain configuration on the first controls, the second controls most likely will not be in the correct position according to the status screens. In this case, the operator will need to physically move the Throttle(s) to the correct display setting and then press on the Override Switch to assume control on the new Helm Station. The status of which Helm Station that has the control will be easily seen as on the helm stations where the control(s) do not match the Displays; the Throttle(s) Displays will turn red or will flash as long as the Throttle(s) position do not agree with the display. The solution shown in FIG. 4 is a quick and easy way to synchronize the Throttle(s) with the displays. As soon as the display stops flashing or changes color from the red, the operator can push the Override switch and now has control.

One other benefit of the Main Computer interaction is the complete monitoring of all the systems involved in high Voltage Energy production, Storage and Usage, whether it is voltage limits, load limits, fuel flow, cooling pressure, temperature limits and their corresponding rate of change. The Main Computer can also monitor selected number of other vessel parameters like vessel speed over ground, vessel speed through the water, heading, water temperature, fuel tank level. In reverse the computer acts as a gateway to the data supplied from the same propulsion systems back into the vessel network for display anywhere required.

The system has been designed so that if it were required, a second Main Computer could be put in parallel with constant synchronization; a different power source and an automatic transparent switch over if a failure were to happen.

Another advantage of having a Main Computer control the operation is the flexibility in using propulsion: Zero Drag, Regeneration, Freeze mode. It is also able to control the sense of rotation of motors. In a multi-engine vessel, some of the propellers can be programmed as counter-rotation propellers to diminish the yaw created by what is commonly known as the prop walk effect. If one installs rotating assemblies on Sail-Drives or Pod-Drives, the system can easily accept the inputs from a 3 axis joystick and move the vessel in all directions irrespective of its heading. This allows for manoeuvring in tight places like rivers and marinas, especially when it is windy or there is current.

With the advent of new energy storage systems coming on line and with the automotive price cutting volume momentum building, the exact type of energy storage system used in conjunction with the system and method of the present invention is not critical. Presently, there are systems based on nanotechnologies (Altair, A123) or new ultracapacitors (Eestor) and others. It is now possible to have a very light, powerful and low internal resistance Energy Storage Units that can be charged and discharged rapidly, (5 to 20 minutes if enough charging power is available) that can be used in a wide range (10% to 90%) for thousands of cycles. It is important to mention the importance of the presence of a Battery Management Computer (BMC), even if new technology offers light high voltage storage units with very low internal resistance, which means that they can be charged and discharged rapidly without incurring large temperature rise. Temperature control was a big problem with all chemical batteries until recently but it is still very important to have a good BMC. Most of the new high capacity industrial Energy Storage Units come with their own BMC. In the past, BMC's were set up to act as policing units to protect the storage units from too rapid charging/discharging, along with the accompanying catastrophic consequences. With the new storage technologies, these BMC are more like a guardian: just supervising each individual cell, monitoring its temperature, helping to equalize and, if necessary, electrically remove cells if they were to become faulty. Such removal has almost no perceivable performance degradation, except for an error message sent to the Main Computer advising that at the next maintenance interval, such a cell should be replaced.

Boat speed is electronically retrieved by either the vessel thru-hull speed sensor, by reading the ground speed output from navigation equipment (GPS) or by momentarily freewheeling the propeller. Thru-hull boat speed will be the preferred input mechanism into the main computer, should there be a significant and sustained difference (not current based) between hull speed and the ground speed output from the navigation system, or should such output not be available, then the main computer will order one of the motor controller to momentarily freewheel its propeller on a recurring basis and retrieve its speed information from it. This failure or discrepancy will be recorded in the main computer database.

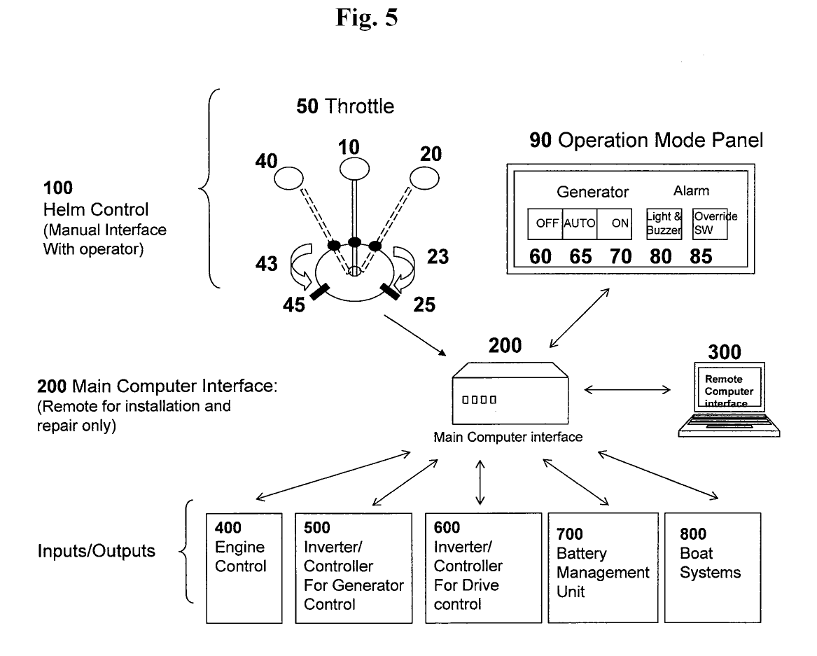

The main interface computer, (FIG. 5) on top of exchanging with and directing the engine controller, the generator controller, the battery management controller, the drive motor controller, the vessel systems and getting input from the helm station(s) controls, also act as a storage unit for historical operational data. It can also act as communication gateway through an external communication unit to the outside world. This communication interface preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/internet protocol (“TCP/IP”), serial line internet protocol/point to point protocol (“SLIP/PPP”), whether WiFi, Cell or Satellite based, and so on, but may also implement customized or non-standard interface protocols as well.

Referring now to FIG. 6, there is shown the logic for the Generator Switch Mode. The module in the PLC that monitors the position of the switch (“Off”, “Auto” or “On”) (Actual mode in the software), requested mode (when the switch is pressed), the generator status (off or on; the load), the battery status (normal high and low charge limits), and the power requested/rate of change in kilowatts/h (determined by propulsion and house loads). The switch module receives that data and determines and executes the status/power change, if required. If the OFF mode is selected, the system will assume electric only operation, the generator will not automatically start and in the case of high voltage electric storage depletion, an alarm and power down mode will be initiated. If the ON mode is selected, the generator will start, fully charge the battery then reduce rpm to match the load requested; this mode is also called abnormal or emergency mode as the maximum power available for propulsion (forward or reverse) will be temporarily increased to the combined power of the generator and the batteries.

Turning now to FIG. 7, there is shown a drawing showing the logic for Idle Reverse Mode. When the throttle is in idle reverse mode the PLC reads the battery status, the boat speed, and the boat data to determine if the motor will be in idle reverse mode, (reverse low-speed propulsion), limited regeneration (limited drag) or no drag mode (propeller rotates at boat speed to prevent drag). The boat type data includes parameters relevant to boat design such as number of hulls, width and length of hull at waterline, weight of boat etc. Limited regeneration is a drag monitoring function that will vary the rate of regeneration depending on battery status, boat speed and hull characteristics. For example, as a heavy displacement hull approaches hull speed, regeneration rate will be increased as it will have little effect on overall speed. As the battery bank reaches the high trigger, the prop will revert in no-drag mode until battery requirements low trigger is reached at which point, limited regeneration mode is re-enabled.

FIG. 8 is a drawing showing the logic for Forward Mode. At low speed, the torque/thrust is logarithmically proportional to the throttle position. As boat speed increases, the torque versus throttle position is monitored, should a drop in torque be registered, a sail assist mode in engaged and the propulsion motors will fluctuate between propulsion and regeneration, as the effects of wind and waves actions on boat speed dictates.

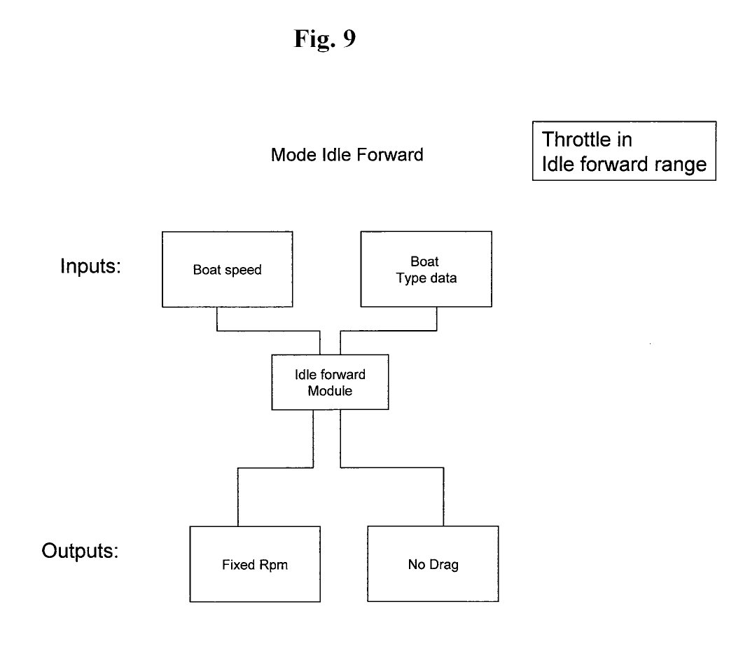

FIG. 9 is a drawing showing the logic for Idle Forward Mode. When the throttle is in the forward idle range, the PLC reads the boat speed, and according to preset parameters relevant to the boat type, it switches the motor to turn the propeller by fixed rpm or in the no-drag mode.

Turning now to FIG. 10, there is illustrated the logic for Reverse Mode. When the throttle is the reverse mode, should the boat speed be above the low speed trigger and be moving forward, the boat will be slowed by entering regeneration proportional to throttle angle. Should the drag request exceed the drag generated by unlimited regeneration or should forward boat speed fall bellow low speed trigger, the propulsion will be switched into normal reverse logarithm proportional to the throttle position. Should constant drag be requested (to slow down in bad weather . . . ) the system then alternates between throttle angle proportional regeneration and reverse dependent on battery status.

In order to validate different aspects of the present invention, a test unit was constructed with the following specifications:

In one embodiment of the invention the main computer is an IQAN-MDL2 Display Module PLC that uses an SAE J1939 “CAN” control area network to interface to the high voltage storage unit, HV-Chargers, Motor/Generator Controllers and Gas/Diesel engines and other vessel sensors and actuators. The system includes a UQM PowerPhase 145 kW motor/generator and its CanBus controller coupled to a Volvo common rail D3 engine controlled by its own CanBus controller, two UQM High torque motors/generator with their own CanBus controllers. The propeller RPM is determined by reading the electric motor rpm through the motor controller and applying a mathematical formula should a gear be installed; the low voltage sensing is determined from an analog to digital sensor that reads the battery voltage; the high voltage sensing is determined from the energy storage controller Battery Management Computer; the generator(s) rpm(s) and power level(s) is obtained and controlled through the generator inverter/controller(s); the engine(s) data is also obtained from CanBus engine electronic control unit(s); and control of the engine(s) is performed through the CAN interface to the engine control unit.

The whole inter-communication of the devices was performed quickly thru the high level programming interface offered by the IQAN plc. Having several J1939 ports on the plc was an advantage as new or non standard components could be added/tested without disturbing the main systems. This also allows devices not built or tested by us to be added to the system without this new device failure having detrimental effects on our primary system. The PLC's ability of being able to independently control gas/diesel engines and of the HVDC generator allows a high degree of optimisation and efficiency.

The highest efficiency gains were in the dynamic control of the regeneration and power/sail assist modes on sailboat, controlling regeneration is extremely important, the associated drag has to be kept to a minimum and be dynamically controlled, but once charging is done, the elimination of drag becomes just as important. In the sail/power assist mode, using the high voltage storage unit and the drive motors as a speed stabilization mechanisms has the benefits of increasing the daily average speed with minimal or no detrimental effect on energy storage, but also has the added benefit of reducing the number sail adjustments due to relative wind changes on a given course.

The choice of using a common-rail diesel motor has been important in the overall efficiency of the design, having a wide efficient RPM band allowed for easy match to the motor/generator.

### Components of a Series Diesel Electric System (FIGS. 1 & 5)

100 Helm Controls: The helm control is the actual manual interface between the operator and the Main Computer. The helm control includes the Operator Mode Panel (90) where Off, Auto, or On mode must be chosen, the Throttle(s) (50) and an alarm and an override switch.

200 Main Computer Interface: Is a new generation programmable logic controller (The Main Controller) preferably rated for rough and humid environments. In a preferred embodiment, it is provided with a minimum of 32-bit technology 16 MB flash memory. It must provide for multiple analog/digital inputs and analog/digital/pwm outputs, be modular in design and have flexible communication pathways for optimal matching controller and external devices for any kind of application. The unit we used had 4 configurable Can busses, 2 RS232 serial and 1 USB 2.0 interface.

300 Remote Computer Interface: The remote computer interface can be a portable computer or the vessel main navigation computer with a display and keyboard which is used to access the programs, to set the default settings and the specialized setting required for specific types of marine vessels and to display actual and historic information and warnings

400 Engine Control: Is the CanBus controlled gas/diesel engine manufacturer supplied engine management system?

401 Engine: Is a gas/diesel engine connected to the motor/generator 501 used as a primary energy producing device on the vessel? One or more of these can be installed in parallel if required as they all produce high voltage DC power for the high voltage energy storage unit 725.

410 Alternator: The alternator is used as an alternate power source to charge the low voltage battery 840 and through the bi-directional DC/DC charger/converter 750 could even help maintain the high voltage storage unit 725 in case of a fault.

420 Starter. The starter is only used in the case of too low voltage in the high voltage storage unit preventing the generator/motor controlled start.

500 Inverter Controller: Is the brain of the motor/generator, it converts the high dc voltage from the storage 725 unit into variable 3 phases ac for motor 501 operation and converts variable ac into dc in generator operation. In a preferred embodiment, it is water cooled and provides for voltage up-scaling so has to provide for full propulsion power even as battery voltage drops, and to provide full high energy storage charging voltage even with slow (100 rpm) propeller speed. It communicates with the Main Computer through CanBus.

501 Electric Motor/Generator: Is a brushless permanent magnet motor/generator built using a high pole count, dense copper fill, rare earth magnets to maximize power and torque. It has a very low weight, casing in aluminum and is water cooled.

700 Battery Management Unit: Is the brain of the storage unit, controls and monitors each cell, help in the equalization process and is able to electrically disconnect a cell from the unit should one be faulty. It communicates with the Main Computer through CanBus.

725 High Voltage Energy Storage: The high voltage storage is a battery bank of high voltage storage. The preferred embodiment of a storage device that can be used is the EEStor (U.S. Pat. No. 7,033,406) with the capability to store electrical energy in the range of 52 kWh. The total weight of an EEstor electric storage device is about 336 pounds, and its system is a type of battery-ultracapacitor hybrid based on barium-titanate powders. Weight for weight, it outperforms lead-acid batteries at half the cost and without the need for toxic chemicals. An alternative energy storage device that could be used in the system is the next-generation type lithium-titanate batteries based on Altair's nanotechnology as in the Terravolt™ units fast-charging energy storage system, or A123 lithium-nanophosphate as used by electric car maker Tesla.

750 DC/DC Bidirectional Charger/converter: This device is primarily used to convert high dc voltage into low dc voltage effectively providing a bridge between the high voltage storage unit and its equivalent in the low voltage side, But it also has the ability through user defined parameters to invert and convert low voltage into high voltage, thus becoming a bi-directional cross charger. An example is the DCDC converters sold by Brusa Electronic AG and it is water cooled.

760 Inverter House Loads: This device takes high volt dc from the high voltage energy unit and produces ac voltage, either 240v 60 hz or 230V 50 hz for vessel loads. An example is Mastervolt 15 kW Sun's inverters.

770 House loads: Since on these hybrid electric vessels, energy storage is usually large, great saving can be accomplished in using normal house appliances in the vessels, whether is it for cooking, air conditioning, hair driers, microwaves, sound systems and so on, in this case, the large storage unit provides several hours if not days an anchor with normal ac power without the generator having to turn on to recharge, and even then, because of the low resistivity of the new technology of the storage units, the generator will only run for a few minutes at optimum power.

800 Boats systems: The boat systems include navigational systems, autopilots, radars, external communication, and systems used in the living quarter of the vessel like low voltage LED lights.

810 External Communications: This device connects directly to the main computer 200 and provides a bidirectional external over the air link to the various communication networks, like cellular, WiFi and satellite. It provides for a complete encrypted and protected access to the Main computer. This can be used to report position on a regular basis or be interrogated by the base about the different boat systems and historical data.

840 Low voltage Energy Storage: This is the 12 volt battery used for typical marine-grade low voltage accessories. This storage does not have to be large or heavy as the Bi-Directional DC/DC unit 750 has a large transfer capacity and can help in supplying intermittent large low voltage loads.

850 Low Voltage Accessories: Include systems used in the living quarters of the vessel (lights, audio/visual entertainment), in the galley (small appliances; cooking apparatus), and low voltage instrument used in navigation (computers, display panels etc)

850 Solar panels: Solar panels can optionally be installed to provide alternative low voltage energy. Solar panels are frequently installed in marine vessels operating in subtropical and tropical region regions.

860 Wind generation: Wind generation devices are optional and are frequently installed by operators undergoing long-distance passages, especially in sailboats.

900 Propellers: Ideally of the fixed multi-blades large pitch propeller type, so has to fully utilize the large torque available from permanent magnet electric motors and be efficient in regeneration. The system can be programmed for other propeller types.

A preferred embodiment of the Main Generator start and stop program logic follows:

Check-Generator-Switch example:

| | |
|---|---|
| If OFF: | If generator operating: Turn off engine controller |
| | Return |
| If AUTO: | Check if engine is operating |

If yes: check energy storage status

If >= 90% call Shutdown: Return

If not: check energy storage status

If <= 10% call Start-up

Return

| | |
|---|---|
| If ON: | Check if engine is operating |
| | If yes: Check generator is operating |

If yes: return
If no: switch motor/generator into generator mode:
Return

If no: Startup:

Return

| | |
|---|---|
| Startup: | |
| | Check high voltage energy storage unit voltage |
| | If too low, call Low-volt-start-up: return |
| | Turn on engine controller |
| | Order generator controller to switch to motor mode |
| | Initiate a rotation above idle setting |
| | Initiate timing |
| | Verify motor load: |
| | If load too high: call Abort: Return |
| | If load normal, check timing |

As timing exceeded: Abort: Return

(Engine is operating)
If engine temperature too cold, wait for temperature rise
Switch generator/motor back into generator
Return

Low-Volt-Startup:

Turn on engine controller
Close motor starter relay
Initiate timing loop on RPM,

In minimum RPM not reached: Abort: Return

| | |
|---|---|
| | (Engine is operating) |
| | If engine temperature too cold, wait for temperature rise |
| | Switch generator/motor into generator |
| | Return |
| Shutdown: | |
| | Turn off motor/generator |
| | If engine temperature very high, wait for temperature drop |
| | Turn off engine controller |
| | Return |
| Abort: | |
| | Turn off electric motor |
| | Turn off engine controller |
| | Turn off low volt starter relay |
| | Send alarm |
| | Return |
| Startup: | |
| | Check high voltage energy storage unit voltage |
| | If too low, call Low-volt-start-up: return |
| | Turn on engine controller |
| | Order generator controller to switch to motor mode |
| | Initiate a rotation above idle setting |
| | Initiate timing |
| | Verify motor load: |
| | If load too high: call Abort: Return |
| | If load normal, check timing |

As timing exceeded: Abort: Return

(Engine is operating)
If engine temperature too cold, wait for temperature rise
Switch generator/motor back into generator
Return

Low-Volt-Startup:

Turn on engine controller
Close motor starter relay
Initiate timing loop on RPM,

In minimum RPM not reached: Abort: Return

| | |
|---|---|
| | (Engine is operating) |
| | If engine temperature too cold, wait for temperature rise |
| | Switch generator/motor into generator |
| | Return |
| Shutdown: | |
| | Turn off motor/generator |
| | If engine temperature very high, wait for temperature drop |
| | Turn off engine controller |
| | Return |
| Abort: | |
| | Turn off electric motor |
| | Turn off engine controller |
| | Turn off low volt starter relay |
| | Send alarm |
| | Return |

The only draw back to full use of this type of energy control is cost, high efficiency motor controllers, high capacity high voltage, low weight and low resistance storage units are just starting to come to market in quantities and are still very expensive. With the ever increasing full cost and larger acceptance of electric power in the transport industry, we have to believe that the cost/benefit ratio will turn to full computer controlled hybrid/electric in the not too distant future.

Although the present invention has been explained hereinabove by way of a preferred embodiment thereof, it should be pointed out that any modifications to this preferred embodiment within the scope of the appended claims is not deemed to alter or change the nature and scope of the present invention.

1. A method for implementing and programming an electronic computer interface (Main Controller) between an operator and on-board devices of a marine vessel, for monitoring, communicating and managing power generation, storage, regeneration and propulsion thereon, said marine vessel including at least one propulsion system, comprising the steps of:
(a) providing a high voltage storage unit;
(b) providing a low voltage storage unit;
(c) providing a DC/DC bidirectional charger/converter;
(d) providing a main controller, said main controller being operatively connected to said high voltage storage unit, said low voltage storage unit, said bidirectional charger/converter and said at least one electric propulsion system; and
(e) providing a helm controller, operatively connected to said main controller, wherein functions of power generation and propulsion are managed without user intervention based on said operator controlling a throttle and a generator mode through said helm control.

2. A method according to claim 1, wherein said generator mode of said helm control has three settings: ON, OFF and AUTO.

3. A method according to claim 1, wherein said main controller is adapted to use a position of said throttle, the speed and stored parameters of said vessel to control forward movement, reverse, emergency power, zero drag, propeller freeze and regeneration.

4. A method according to claim 1, wherein said method further includes the step of starting and stopping said propulsion system, wherein said propulsion system is connected to at least one generator, the generators being connected either directly or through an electric clutch to the propulsion system and wherein the start/stop sequence can be initiated by either the propulsion or the energy storage.

5. A method according to claim 1, wherein said main controller further includes subsystem for electronically modulating starting and stopping cycles in order to avoid thermal shock and allow time for thermal equalisation.

6. A method according to claim 1, further comprising providing a visual interface providing energy storage state of charge, status of generator, energy depletion/accretion rate and alarms which are dynamically adjusted by the throttle(s)/joystick(s) setting.

7. A method according to claim 4, wherein boat speed is electronically retrieved by the vessel thru-hull speed sensor, by momentarily freewheeling the propeller, by reading the ground speed output from navigation equipment, or by a combination thereof.

8. A system monitoring, communicating and managing power generation, storage, regeneration and propulsion on a marine vessel, said marine vessel including at least one propulsion system, said system comprising:
a high voltage storage unit;
a low voltage storage unit;
a DC/DC bidirectional charger/converter;
a main controller, said main controller being operatively connected to said high voltage storage unit, said low voltage storage unit, said bidirectional charger/converter and said at least one electric propulsion system; and
a helm controller, operatively connected to said main controller, wherein functions of power generation and propulsion are managed without user intervention based on said operator controlling a throttle and a generator mode through said helm control.

9. A system according to claim 8, wherein said main controller is further adapted to electronically cancel the drag associated with at least one propeller connected to an electric motor, by ordering a motor controller associated with each of said at least one propeller to switch to torque mode and supplying a variable amount of power to said at least one propeller, so that no drag is created.

10. A system according to claim 9, wherein said at least one propeller is of the fixed, feathering, folding or variable pitch type.

11. A system according to claim 8, wherein said main controller is further adapted to electronically freeze a free wheeling propeller connected to an electric motor without using mechanical stop devices, by electronically ordering the motor controller to send a very small current in two opposite phase of the motor.

12. A system according to claim 8, wherein said main controller is further adapted to electronically engage/disengage and modulate a hydro-electric regeneration mode on at least one electric driven propeller by regulating a regenerative power based on speed through the water, energy storage requirements, number of hull(s), weight, width and length at the water line of vessel.

13. A system according to claim 8, wherein said main controller is further adapted to electronically change the motor controller modes from propulsion to regeneration and back, and from torque to rpm, to voltage and back, depending on wind and wave action in motor sailing conditions, by using the vessel speed data, the computed vessel performance, the motor drain and by the thrust/rpm requirements of the helm controls.

14. A system according to claim 8, wherein said main controller is further adapted to electronically reverse the rotation of at least one of said at least one propeller on a multi drive system, in order to reduce the yaw created by the propeller walk effect and thus reduce drag and improve efficiency and control by reversing the commands to the motor controller when a reverse pitch propeller is present on said vessel.

15. A system according to claim 8, wherein said main controller is further adapted, to electronically control the angle of rotation on sail drives or pod drives on marine vessels so equipped, providing complete azimuth control irrespective of the heading of the vessel, by reading the inputs from a three-axis joystick (forward, reverse, rotation) and using vessel GPS, sent commands to the motor controller and to the drive steering mechanism.

16. A system according to claim 8, wherein said main controller is further adapted to electronically start a marine gas or marine diesel engines connected to generators, the generators being connected either directly or through an electric clutch to the gas/diesel engines, by ordering the motor/generator controller into motor mode, and then turn the engine up to idle RPM while simultaneously energising the engine controller.

17. A system according to claim 8, where the throttle(s)/joystick(s) inputs are electronically monitored and adjusted via a PID (Proportional Integrating Derivative) and mathematical formulas in order to provide a logarithmic response curve to operator inputs and also provide a smooth transition from forward to reverse and back in case of rapid and extreme throttle movements, thus allowing the mechanical propeller (time to adjust, by reading the operator input over time and using dynamically updated logarithmic curve and PID switch delays, ordering the motor controller to respond using the modified values so that, over time the motor rpm will match the operator request.

18. A system according to claim 8, wherein said vessel includes at least two electric propulsion motors, and wherein said main controller is adapted to provide an automatic synchronisation if the RPM difference is less than a predetermined amount between the propellers.

19. A system according to claim 18, wherein said system further includes a harmonic noise detector, and wherein if harmonic noise from the synchronized props is detected, a propeller dephasing parameter is applied.

20. A system according to claim 17, wherein if the throttles are within 10% of maximum travel and the generator control mode switch is ON, the maximum power available for propulsion is controlled by the status of the generators and the state of the energy storage unit and their internal temperatures, thereby allowing momentary emergency thrust by combining the output of the generator and the battery.

21. A system according to claim 17, where if a failure in the cooling system of engine, controller(s) and motor(s)/generator(s) (over temperature or pressure drop) develops, the main computer will initiate a visual and auditory warning and reduce the power of the problematic device to an acceptable non-cooling level, until the operator intervenes.
